(19) United States
(12) Patent Application Publication
(10) Pub. No.: US 2016/0004759 A1
(43) Pub. Date: Jan. 7, 2016

(54) Platform for Managing and Visualizing Data on a Computer

(71) Applicants: Adarsh Ramakrishnan, Charlottesville, VA (US); Michael B. Michon, River Forest, IL (US)

(72) Inventors: Adarsh Ramakrishnan, Charlottesville, VA (US); Michael B. Michon, River Forest, IL (US)

(21) Appl. No.: 14/749,739

(22) Filed: Jun. 25, 2015

Related U.S. Application Data
(60) Provisional application No. 62/020,587, filed on Jul. 3, 2014.

(51) Int. Cl. G06F 17/30; G06F 3/0484; H04L 29/06

(52) U.S. Cl. CPC G06F 17/30572; H04L 65/403; G06F 17/30589; G06F 3/0484

(57) ABSTRACT

A method of compiling, organizing, and presenting data is described. In embodiments, the method comprises importing and consolidating hierarchical data from multiple project management and/or data storage platforms using one or more application programming interfaces (APIs) and/or one or more direct interfaces with one or more computing devices, converting one or more collections of the hierarchical data into a node, which is a data collection capable of providing for user collaboration, reconfiguring the hierarchical data by applying an algorithm, which algorithm is capable of using one or more data types to reconfigure the data, displaying the hierarchical data as a graph and/or graphic, and enabling a data user to create user-defined graphs as visual displays. Additional embodiments include a non-transitory computer readable storage medium and a graphical user interface providing this functionality.

### CROSS-REFERENCE TO RELATED APPLICATIONS

This application relies on the disclosure of and claims priority to and the benefit of the filing date of U.S. Provisional Application No. 62/020,587 filed Jul. 3, 2014, the disclosure of which is hereby incorporated by reference herein in its entirety.

### BACKGROUND OF THE INVENTION

1. Field of the Invention

Embodiments of the present disclosure relate to computer-implemented methods of compiling, organizing, and presenting data. More particularly, embodiments of the present disclosure relate to computer-implemented methods for intuitive visualization of network and hierarchical data that provides for a collaborative computing environment.

2. Description of Related Art

Managing and sharing data and files in modern day computing environments has become an exceedingly complex task. Computing projects which require multiple users to share files from multiple, diverse applications over a network result in workflows that are less than optimal for providing a user-friendly computing environment. Existing file management and storage solutions tend to be inefficient, as there are typically multiple places to store files without a single location linking all of these places together. Additionally, current data visualization paradigms tend to be hierarchical and do not resonate with our form of thinking and reasoning.

While efforts have been made to address these issues including those described in U.S. Patent Application Publication Nos. US 20140096088 and US 20140095972, both of which are hereby incorporated by reference in their entireties, there is a need for a platform that allows individuals and organizations to better visualize their entire network and/or hierarchical data that is more intuitive than existing solutions. Additionally, there is a need for a system that allows individuals and organizations to collaborate with other individuals and/or organizations through this visualization to allow for more intuitive workflows.

### SUMMARY OF THE INVENTION

The present disclosure provides a method and platform that allows a user to store and access files across multiple storage spaces securely and efficiently. In embodiments, provided is a method of presenting data on a virtual canvas, the method comprising: (a) importing and consolidating hierarchical data from multiple data storage and/or project management platforms; (b) sorting and mapping the hierarchical data into a collection of a series of data points with parent-child relationships; assigning a node to each data point, populating each node with meta-data associated with the data point the node represents, and displaying the nodes and their parent-child relationships on a virtual canvas; (c) creating a collaborative environment on the virtual canvas by converting each data point into a collaborative node that allows for sharing of and collaboration at the nodes between users by way of a chat interface, file sharing platform, and/or content management system; and (d) re-configuring the relationships between collaborative nodes using a computer processor to relate and sort data according to user-defined criteria, moving one or more of the data points to a different position on the virtual canvas, and displaying the nodes and their re-configured parent-child relationships on the virtual canvas.

A user can be (but is not limited to) a human, a computer, a computer script, a computer algorithm, a mechanical input device, a signal (such as infrared or Bluetooth), an audio cue (voice recognition), a visual cue (blink inputs), a hand gesture (e.g., Kinect), or any other human input device. In embodiments, the method and platform allow for the importing (usually by a user) of existing files from other data, data storage and/or project management platforms, turn each folder into a collaborative environment, and visualize the entire network as an intuitive graph and/or graphic. Further, embodiments of the method and platform allow a user to organize file management and sharing across a variety of cloud networks and provide for collaboration and management of resources of a diverse array of projects. In this way, the present invention solves a problem rooted in computer technology and improves the functionality of computer systems by creating a means for users to more efficiently import and organize data, visually represent the relationships between data more intuitively than standard operating systems, and provide virtual spaces for collaboration among users, all within the same platform.

Embodiments allow users to create visualizations of their network and/or hierarchically organized data, create collaborative spaces within their network and/or hierarchically organized data, and manage resources through these collaborative spaces. These collaborative spaces may have a variety of applications, including file sharing, task management, human resource management, workflow creation, and other uses pertaining to project management and/or monitoring. Users can consolidate their file/folder structures from multiple sources through the use of third party application programming interfaces (APIs) as well as direct access to their computing devices. Additionally, embodiments of the method and platform allow a user to import existing data hierarchies, create an intuitive graph and/or graphic from the inputted data hierarchies, assign nodes to folders and allow for the import and creation of files, share files with internal or external users, and give users the ability to assign/monitor tasks, schedules, and contacts relevant to each node.

Embodiments of the disclosure also have relevance to several fields, including project management, software development, networking, and mind-mapping. Mind-mapping is a process used to visually outline information by showing the relationships between thoughts centered around a key concept or central idea.

Embodiments also allow project and product managers coordinating inputs from multiple contractors and sources (such as freelancers, external agencies, departments within an organization, etc.) to efficiently manage their human resources. For example, the project manager could set up a file structure and then import this file structure into the proposed system. The system would then allow the project manager to quickly manage permissions across the entire project, view the project geographically, manage files and resources, and quickly find appropriate resources.

Some embodiments relate to network visualization. A user can import a set of hierarchically arranged data and create a network map to see how various nodes within a network are interacting. Users can import metadata relevant to each of these nodes as well. Metadata can provide information such as date creation, device specs, authors, and so on, which will help the user and/or algorithms to better process data. This visual will provide users with insights that would otherwise be missed since the relationships are created per a user's inputted parameters.

A further embodiment of the disclosure provides creation of mind-maps based on a user's inputs. A user can take any hierarchical data set, set a root node, and map or graphically present the dependent nodes as a mind-map showing the relationship between nodes. Unlike some existing mind-mapping software, (such as Freemind and XMind) the mind-map of this disclosure provides an interface for user collaboration, allowing a user to begin executing the idea directly from the platform. For example, user collaboration can occur passively through Atom sharing (i.e. a user is shared on an Atom and can monitor progress at will) or actively through interacting with an Atom (i.e. a user shared on an Atom uploads files, adds tasks, assigns tasks, adds contacts, etc.).

An exemplary embodiment comprises a method of compiling, organizing, and presenting data. The method may comprise one or more of importing and consolidating hierarchical data from multiple data storage and/or project management platforms using one or more application programming interfaces (APIs) and/or one or more direct interfaces with one or more computing devices, converting one or more collections of the hierarchical data into a node, which is a data collection capable of providing for user collaboration, and reconfiguring the hierarchical data by applying an algorithm. In embodiments, the algorithm is capable of using one or more of the following data types to reconfigure the data: Geodata, Dates, Times, Keywords, Contacts, Metadata, Hit counts, Number of files, Number of folders, Etc. Embodiments include the displaying or presenting of the hierarchical data as a graph and/or graphic, and enabling a data user to create user-defined graphs as visual displays.

Embodiments include reading a hierarchical structure, metadata, and associated data for the hierarchical data to perform the reconfiguring, and converting the hierarchical data into a branch, wherein a branch is a connected subgraph of one or more nodes in which each limb (or edge) is directed and connects a parent node to one of its child nodes.

In embodiments, the method further comprises providing the user with an ability to edit the branch by removing and rearranging nodes and connections or by importing metadata, associated data, and/or links to metadata and/or associated data.

In embodiments, the method further comprises for providing for user collaboration involving one or more of task or project management, task or project tracking, task or project scheduling, file storage, and/or file management.

In embodiments, the method further comprises assigning nodes to represent collections of data, i.e., a collection, wherein the nodes are capable of providing for the import and creation of files by the user, providing for the sharing of files with internal or external users, and providing the user with an ability to assign and/or monitor tasks, schedules, and/or contacts relevant to each node.

In embodiments, the hierarchical data is capable of being stored and accessed across multiple storage spaces.

In embodiments, a node is any data set with a data hierarchy.

In embodiments, the node is a digital container, such as a bin, which is capable of collecting, capable of collecting, storing, and displaying any data and/or metadata requested by an algorithm and/or user input. These bins will function like traditional folders, but offer the user more functionality (such as collaborative platforms, updating, and visual layers to make understanding the data contained within the bin easier to visualize and understand).

In embodiments, the node is capable of providing users with a user interface for displaying relationships between data points.

In embodiments, the node is capable of providing users with a user interface through which users can collaborate and communicate.

In embodiments, the node is capable of providing users with a user interface within which users can store and/or link to data and/or metadata.

In embodiments, the node is capable of providing users with a user interface through which users can import and/or transfer data and/or metadata.

In embodiments, the node is capable of providing users with a user interface from which users can reconfigure a structure of stored and/or linked data.

In embodiments, the method is performed by a processor of a cloud computing server.

In embodiments, the hierarchical data is displayed as a graph and/or graphic on a remote computer which accesses the cloud computing server.

An exemplary embodiment comprises a non-transitory computer-readable storage medium storing one or more programs. The one or more programs comprise instructions, which when executed by a computing device are capable of causing the device to perform any method of the invention, such as one or more of the following: (a) import and consolidate hierarchical data from multiple data storage and/or project management platforms; sort and map the hierarchical data into a collection of a series of data points with parent-child relationships; (b) assign a node to each data point, populate each node with meta-data associated with the data point the node represents, and display the nodes and their parent-child relationships on a virtual canvas; (c) create a collaborative environment on the virtual canvas by converting each data point into a collaborative node that allows for sharing of and collaboration at the nodes between users by way of a chat interface, file sharing platform, and/or content management system; and (d) re-configure the relationships between collaborative nodes using a computer processor to relate and sort data according to user-defined criteria, move one or more of the data points to a different position on the virtual canvas, and display the nodes and their re-configured parent-child relationships on the virtual canvas.

The algorithm will take the listed data and correlate it with both the user's data as well as anonymized data about other users' activities to provide suggestions for workflow improvement, better data management practices, potential collaborators, and other information that would provide a user with further insights from data analysis.

Embodiments include a non-transitory computer-readable storage medium which is accessible to a cloud computing server.

An additional exemplary embodiment comprises a graphical user interface on a computer comprising a dashboard configured for:

a) displaying a visual representation of hierarchical data as a graph and/or graphic;

b) displaying the hierarchical data as a plurality of collaborative nodes:

wherein one or more of the plurality of nodes are configured for enabling users to collaborate and communicate by way of the nodes; and

wherein one or more of the plurality of nodes is a digital container, such as a bin, capable of collecting, transferring, storing, linking, and/or displaying data and/or metadata requested by an algorithm and/or user input;

c) displaying relationships between data points provided by the nodes;

d) and reconfiguring a structure of stored and/or linked data by a user.

Embodiments include a graphical user interface which is accessible through a cloud computing server by one or more remote computers.

### BRIEF DESCRIPTION OF THE DRAWINGS

The accompanying drawings illustrate certain aspects of embodiments of the present invention, and should not be used to limit or define the invention. Together with this disclosure the drawings serve to explain certain principles of the invention.

FIG. 1 is a schematic diagram showing a user flow process according to an embodiment of this disclosure.

FIG. 2 is a schematic diagram showing an application interface process according to an embodiment of this disclosure.

FIG. 3 is a schematic diagram showing an internal service data processing algorithm according to an embodiment of this disclosure.

FIG. 4 is a schematic diagram showing macro data flow according to an embodiment of this disclosure.

FIG. 5 is a screenshot showing a non-limiting example of a network graph and/or graphic of a representative graphical user interface (GUI) of this disclosure.

FIG. 6 is a screenshot showing a non-limiting example of an individual node or “Atom” of a GUI of this disclosure.

FIG. 7 is a screenshot showing a non-limiting example of the content of an individual node or “Atom” of a representative GUI of this disclosure.

FIG. 8 is a screenshot showing a non-limiting example of a Toolbar with Tasks and Files of a representative GUI of this disclosure.

FIG. 9 is a screenshot showing a non-limiting example of a Toolbar with an Edit function of a representative GUI of this disclosure.

FIG. 10 is a screenshot showing a non-limiting example of a Toolbar listing Contacts of a representative GUI of this disclosure.

FIG. 11 is a screenshot showing a non-limiting example of a General Network of a representative GUI of this disclosure.

FIG. 12 is a screenshot showing a non-limiting example of a General Network with Search Results of a representative GUI of this disclosure.

FIG. 13 is a screenshot showing a non-limiting example of a Context Menu of a representative GUI of this disclosure.

FIG. 14 is a screenshot showing an API import screen of a representative GUI of this disclosure.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

Embodiments of this disclosure provide a method of compiling, organizing, and presenting data. In embodiments, the method includes importing and consolidating hierarchical data from multiple data storage and/or project management platforms using one or more application programming interfaces (APIs) and/or one or more direct interfaces with one or more computing devices. Additionally, the method includes converting one or more collections of the hierarchical data into a collaborative node, which is a visual representation of a data collection capable of providing for user collaboration. In embodiments, this converting step involves a series of substeps which will be described as follows. In one embodiment, hierarchical data (i.e. data where one item is a parent/child of another item) is first selected/imported into a database. This import can occur manually (i.e. manual input of data points), via an application programming interface, automatically (i.e. from a live updating data set), or through another means of digital interface. The data is then sorted, and the parent/child relationship is mapped by an algorithm. This is to show how data points are related both upstream (i.e. with parents) and downstream (i.e. with children). Nodes (also referred to as Atoms in this disclosure) are assigned to each data point. Nodes are then populated with names, dates, geodata, and other meta-data associated with the data point the node represents. This meta-data is collected from the original data set during the import. These nodes are then drawn as circles on a digital canvas, with lines (also referred to as Branches in this disclosure) drawn between related nodes. This represents a visual depiction of the hierarchical data as a series of interrelated nodes. Once the algorithm has imported the data, sorted the data, and mapped the nodes, a collaborative environment is finally created on the canvas. This environment allows nodes that are shared by the user(s) (either manually or automatically) to collaborate with other users they have shared this node with. In one embodiment, the algorithm creates a basic chat interface, file sharing platform, and content management system. In other embodiments, the algorithm can smartly predict what collaborative features to include on a node based on the data point the node is created from.

Dependencies are determined between parent/child relationships based on the structure of the data. The first column of the imported data is set as the top level “parent” (unless specified otherwise by the user), and subsequent columns and arrays are linked to items in the preceding column. Once these relationships are determined, user-set permissions are sorted and applied to appropriate parent and children relationships. These permissions control the flow of the information to and from each data point, as well as what can be accessed by different user types for each data point.

After the converting step, embodiments of the invention include reconfiguring relationships between the collections of the hierarchical data by applying an algorithm capable of relating and sorting two or more data. The two or more data may be selected from the group consisting of Geodata, Dates, Times, Keywords, Contacts, Metadata, Hit counts Number of files, Number of folders. In embodiments, this reconfiguring step involves a series of substeps as will be described as follows. First, once a hierarchical data set has been imported and a canvas created for this data, the relationship between nodes needs to be determined. This is done based off of both the hierarchical relationship between items in the data set, as well as the meta-data associated with each data point. Based on a user's inputs, the algorithm can be used to sort data and re-configure the relationships within a data set using this meta-data. This reconfiguring follows a basic logic flow of the following steps. First, a user inputs parameters and criteria for re-organizing a data set, then the algorithm reads the data set and looks for the user-defined criteria. Then, for data points that meet the user-defined criteria, an appropriate sorting method is used to move the data point relative to its parent/child data points. Finally, the new data set is then used in conjunction with the method described above to create a digital canvas.

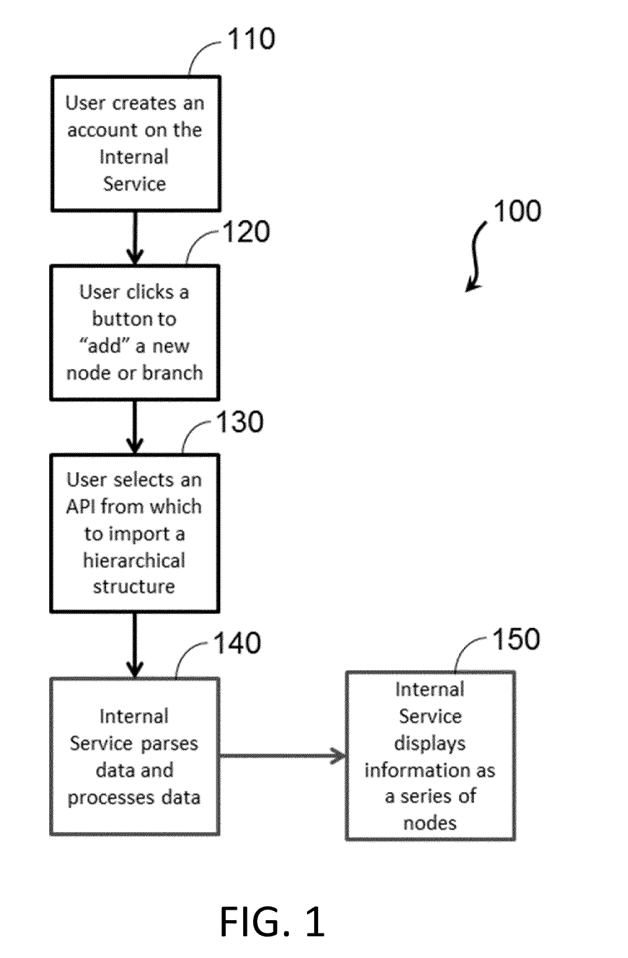

The above steps will be further illustrated and elaborated upon in the following figures. FIG. 1 shows an embodiment 100 of a user interaction process according to this disclosure. In this embodiment, the user interacts with an “Internal Service” to differentiate from external services with which the platform interacts. External services may include online file-storage sites, personal computers, FTP servers, online task management applications, and other tools used for data handling that can be interfaced with either through an API or a direct connection. In a first step, a user will create an account on the internal service 110. Once the user has on-boarded basic information such as their name, email address, and password, they will be taken to a starting screen. From here, the user can add a new single node (i.e. a connector which can be used as a collaborative environment and/or as an anchor for attaching other nodes) and/or add/import a branch 120 (i.e. a collection of nodes that are hierarchically related). When importing a branch, the user selects an API 130 or method to interface with an external service, and then selects a root node (i.e. the node defined as having no parent nodes). The internal service will then parse (i.e. read in using backend logic and sort into parent/child relationships) the hierarchical data 140, setting the user-defined root node as the starting node. Once the data is parsed, the internal service displays the hierarchical relationships to the user 150. The user can continue adding nodes or editing the network by for example re-arranging nodes, adding or removing nodes, and so on.

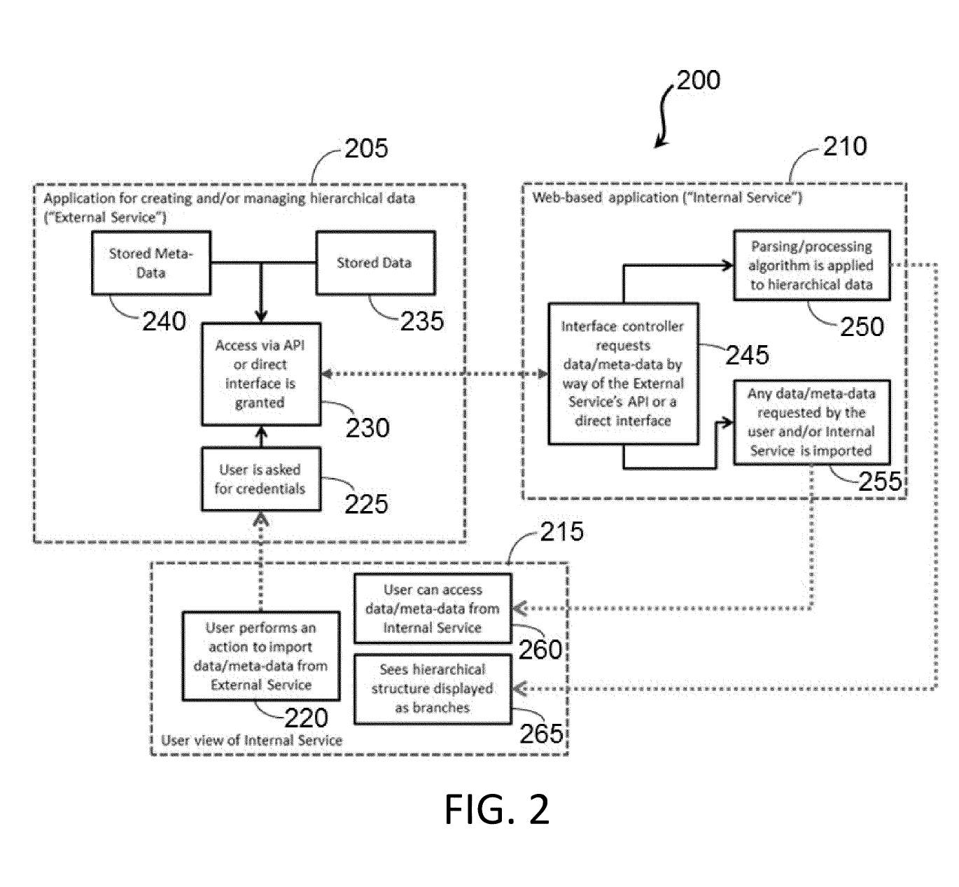

FIG. 2 shows an embodiment 200 of the relationship between external services 205, the Internal Service embodiment 210, and the user view 215. This embodiment is dichotomized into the user-facing view of the internal service and the “back-end” of the internal service. The user can use the user interface of the internal service to call data from an external service 220. This external service 205 goes through a standard application authorization protocol 225 and grants access to the internal service via an application programming interface (API) 230 or some other form of direct interface including (but not limited to) a wired connection, wireless data transmission, or manual data entry/input. From here, any stored data 235 and/or metadata 240 that the internal service requests is sent to the internal service's controller 245 (i.e. the interface between the backend of the internal service and all external services). A parsing/processing algorithm 250 may be applied to the hierarchical data, and any data/metadata requested by the user and/or Internal Service may be imported 255. From here, the user can use the user interface to either view the data/metadata 260 OR view the visual output of the parsing algorithm 265 that the internal service applies to the data.

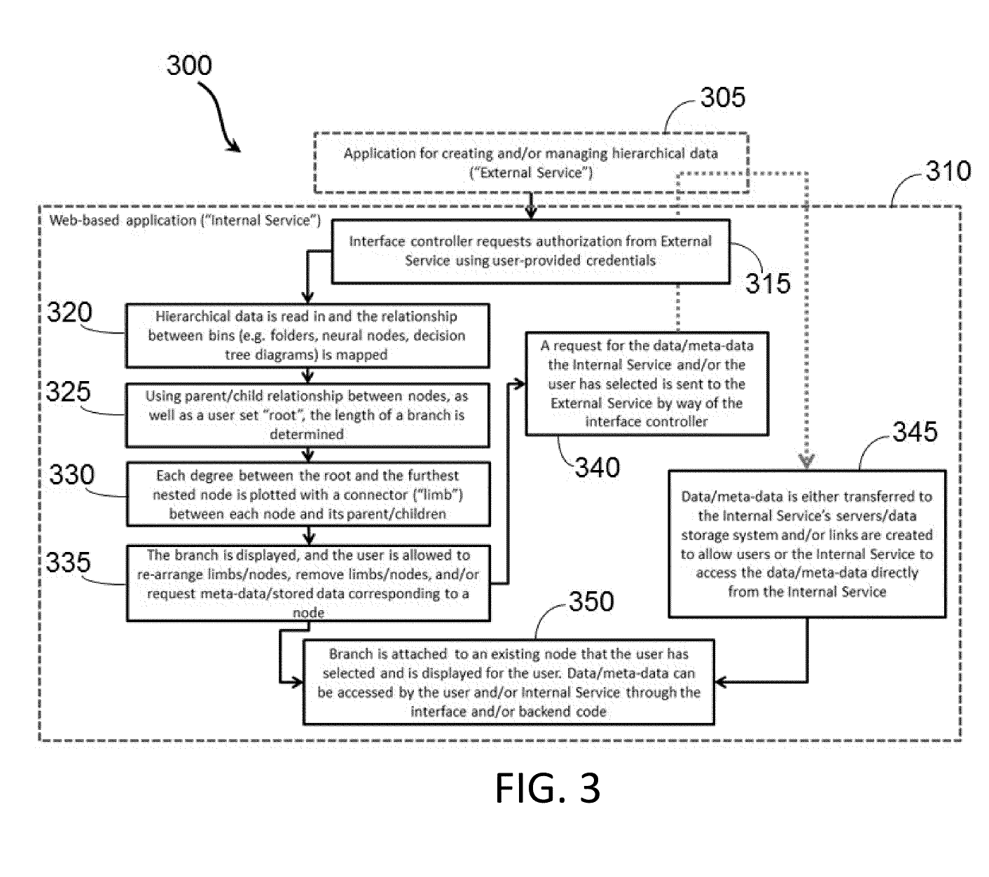

FIG. 3 shows an embodiment 300 of the relationship between an external service 305 and the internal service 310. It also details an exemplary algorithm that can be used by the internal service to produce the output visualization. When a call is made by the controller for data from an external service, credentials are provided and authenticated 315, typically using an OAuth (i.e. the open authorization standard) or similar token scheme. The hierarchical data is then read by the internal service, and relationships between nodes (which can be any sort of bins, folders, decision trees, etc.) are mapped 320. In this context, the term “reading” refers to simply taking the data and looking for the relationships mentioned in the following lines. This relationship is then broken down into a series of parent/child relationships between nodes, with branches being formed from the user defined root node, and the length and/or size (i.e., number of nodes) of the branch is determined 325. In embodiments, determining the length of the branch allows the visual medium to properly plot the branch from a user defined root to the user defined terminal node. It also allows the platform to track such metrics as average branch lengths, allowing for more robust algorithms.

Limbs are plotted between a parent node and its children node(s) 330, and branches are displayed 335. Users can then choose to rearrange limbs/nodes, remove limbs/nodes, and/or request additional data/metadata corresponding to a given node 335. In the latter case, a request for data is sent back to the external service via the controller 340, and data is transferred to the Internal Services data storage system 345. Finally, the branch is attached to the user's existing network 350 as defined by the user. User definitions can include location of the branch, which node to attach the branch to, which parts of the branch to display, and how the branch interacts with other branches. At this stage, all data/metadata imported into the internal service can be accessed by the user and/or internal service through the user interface and/or the backend code.

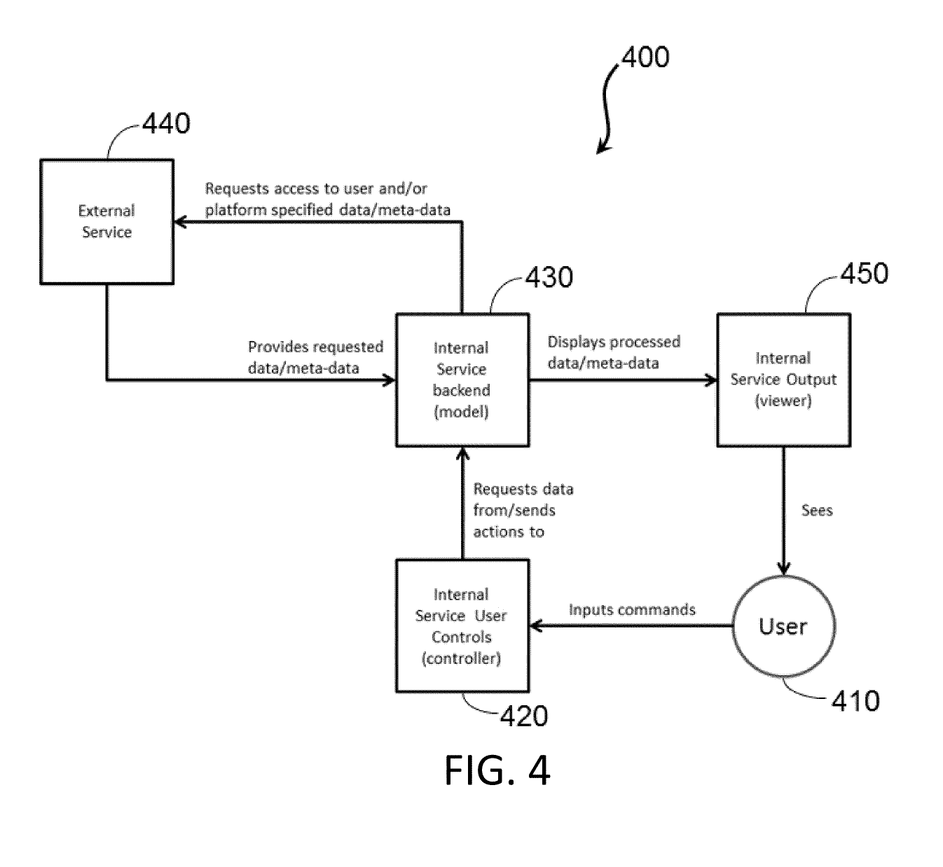

In FIG. 4, the Model-View-Controller design pattern 400 is diagrammed within the context of this disclosure. The user 410 uses the internal service's user interface as the controller 420 to modify the internal service's backend (i.e. model) 430. This model interfaces with the external services 440 and/or runs algorithms and commands based on the user inputs. These algorithms will aid users with visualizing their information as well as with decision making through the use of the data called using the method described in the description for FIG. 3, as well as the following data: Geodata, Dates, Times, Keywords, Contacts, Metadata, Hit counts, Number of files, and/or Number of folders.

Finally, the user sees 450 (via the display) the outputs of the model in the user interface, which serves as a viewer.

The embodiments of this disclosure described herein may be enabled in computer executable instructions which may be organized into routines, subroutines, procedures, objects, methods, functions, or any other organization of computer-executable instructions that is known or becomes known to a skilled artisan in light of this disclosure, where the computer-executable instructions are configured to direct a computer or other data processing device to perform the processes, operations, and algorithms of this disclosure. The computer-executable instructions may be written in any suitable language, non-limiting examples of which include C, C++, C#, Visual Basic, Java, Python, Perl, PHP, Html, CSS, and JavaScript.

Embodiments of the disclosure also include a non-transitory computer-readable storage medium comprising one or more computer files comprising a set of computer-executable instructions for performing the processes, operations, and algorithms of this disclosure. In exemplary embodiments, the files may be stored contiguously or non-contiguously on the computer-readable medium. Embodiments may also include a computer program product comprising the computer files, either in the form of the computer-readable medium comprising the computer files and, optionally, made available to a consumer through packaging, or alternatively made available to a consumer through electronic distribution. As used in the context of this specification, a “non-transitory computer-readable medium” may include any kind of computer memory, including magnetic storage media, optical storage media, nonvolatile memory storage media, and volatile memory. Non-limiting examples of non-transitory computer-readable storage media include floppy disks, magnetic tape, conventional hard disks, CD-ROM, DVD-ROM, BLU-RAY, Flash ROM, memory cards, optical drives, solid state drives, flash drives, erasable programmable read only memory (EPROM), electrically erasable programmable read-only memory (EEPROM), non-volatile ROM, and RAM.

Additional embodiments of this disclosure may comprise or be enabled in a computer system for carrying out the computer-implemented method of this disclosure. The computer system may comprise at least one processor for executing the computer-executable instructions, a memory, a user interface, and a set of instructions (e.g. software) stored in memory for carrying out the method. The computer system can include a stand-alone computer, such as a desktop computer, a portable computer, such as a tablet, laptop, PDA, or smartphone, or a set of such computers connected through a network. The network may use any suitable network protocol, including IP, TCP/IP, UDP, or ICMP, and may be any suitable wired or wireless network including any local area network, wide area network, Internet network, telecommunications network, Wi-Fi enabled network, or Bluetooth enabled network. In one embodiment, the computer system comprises a central computer connected to the internet that has the computer-executable instructions stored in a memory. The central computer may perform the computer-implemented method based on input and commands received from remote computers through the internet such that the central computer serves as a cloud computing server. The cloud computing server may include a copy of the computer-executable instructions stored on a non-transitory computer-readable storage medium loaded in a drive or other input device of the cloud computing server. In another embodiment, the computer system comprises a plurality of computers or computing devices with the set of computer-executable instructions loaded in the memory of each computer or computing device that is part of the system.

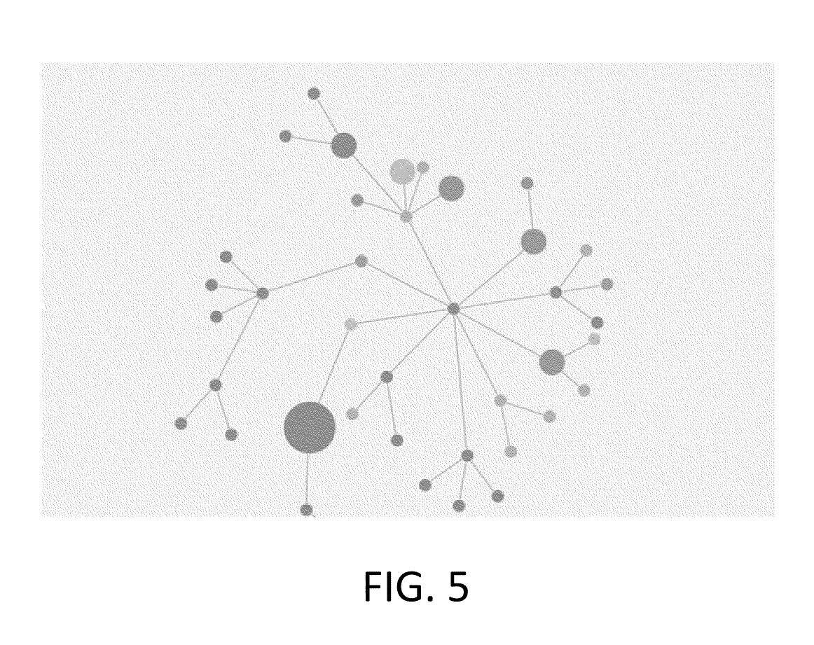

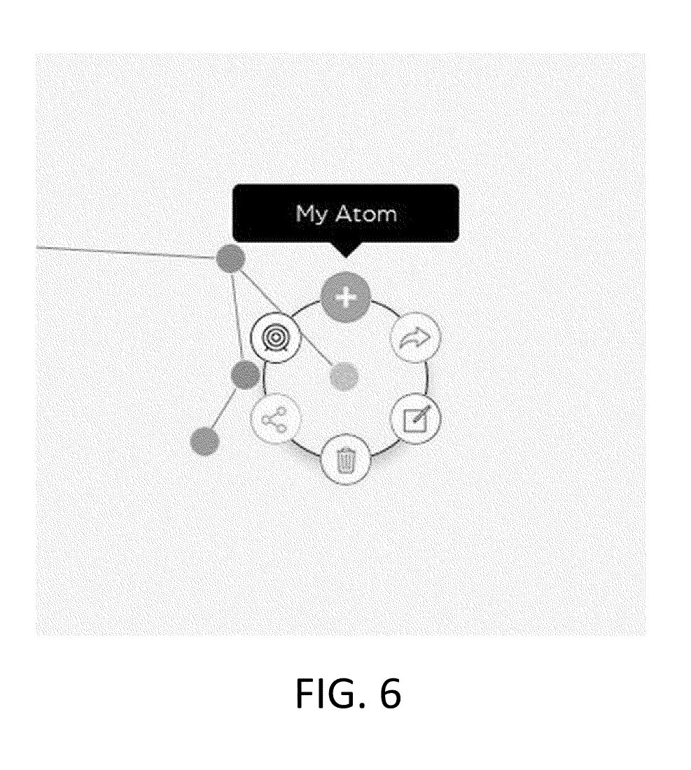

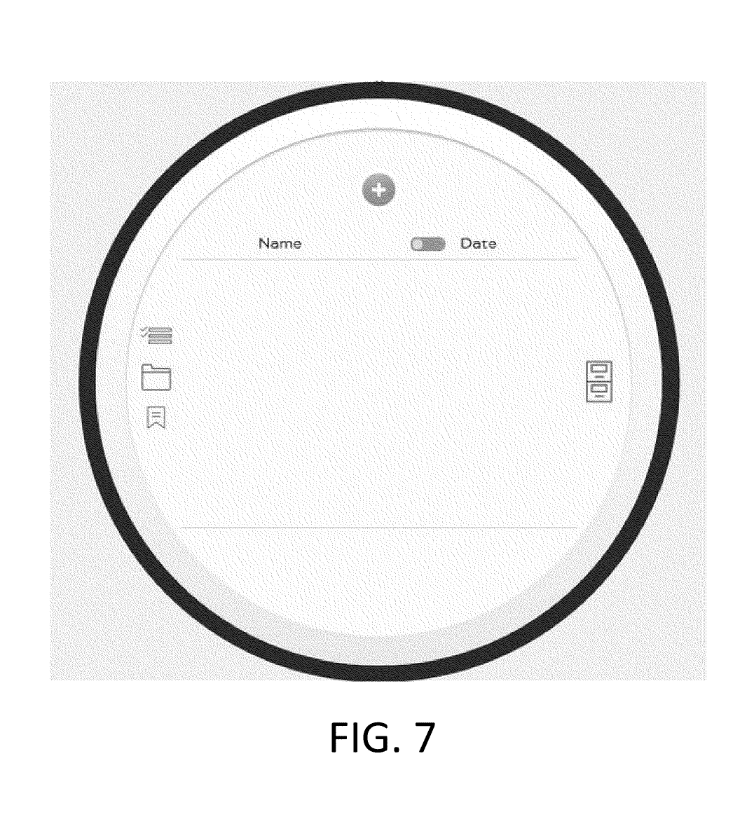

The embodiments of this disclosure may be additionally enabled in a GUI which may be used in conjunction with the computer-executable code. The GUI may allow a user to perform an action to import data/metadata from External Service, access data/metadata from Internal Service, or see hierarchical structure displayed as branches. The GUI may comprise a dashboard configured for displaying a visual representation of hierarchical data as a graph and/or graphic, displaying the hierarchical data as a plurality of collaborative nodes, wherein one or more of the plurality of nodes are configured for enabling users to collaborate and communicate by way of the nodes, and wherein one or more of the plurality of nodes is a virtual container, such as a bin, capable of collecting, transferring, storing, linking, and/or displaying data and/or metadata requested by an algorithm and/or user input. The GUI may be further configured for displaying relationships between data points provided by the nodes, and reconfiguring a structure of stored and/or linked data according to user-defined criteria. The GUI may be accessible through a cloud computing server and may be displayed on a webpage that may be accessed through an industry-standard internet browser such as MOZILLA FIREFOX®, GOOGLE CHROME™, APPLE SAFARI®, and MICROSOFT INTERNET EXPLORER®. Non-limiting examples of a GUI of the disclosure are shown in FIGS. 5-7. For example, FIG. 5 shows a non-limiting example of a network graph and/or graphic, FIG. 6 shows a non-limiting example of an individual node (also called an “Atom” in this disclosure), and FIG. 7 shows a non-limiting example of the content of an individual node or “Atom”.

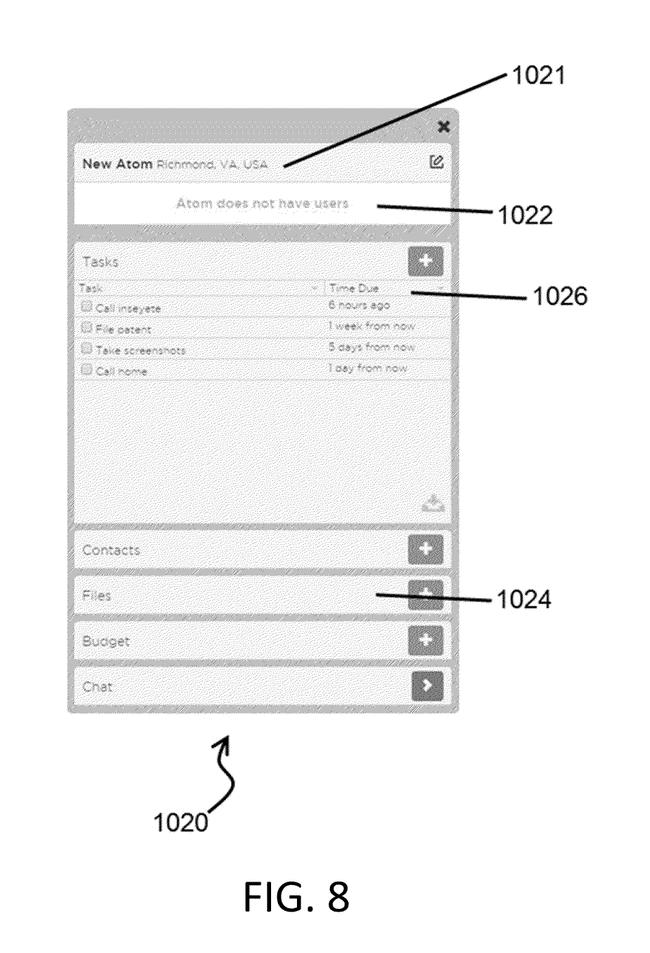

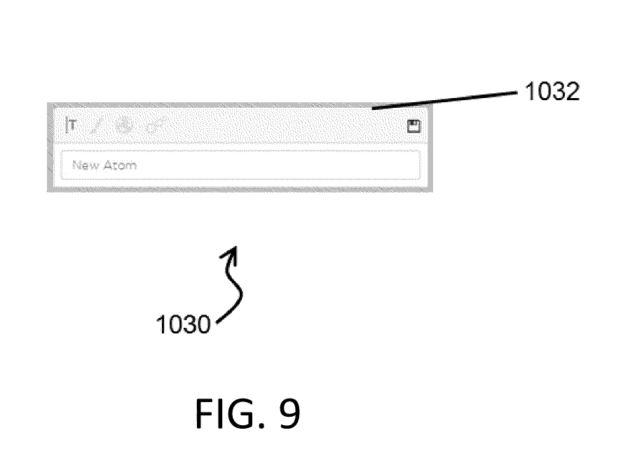

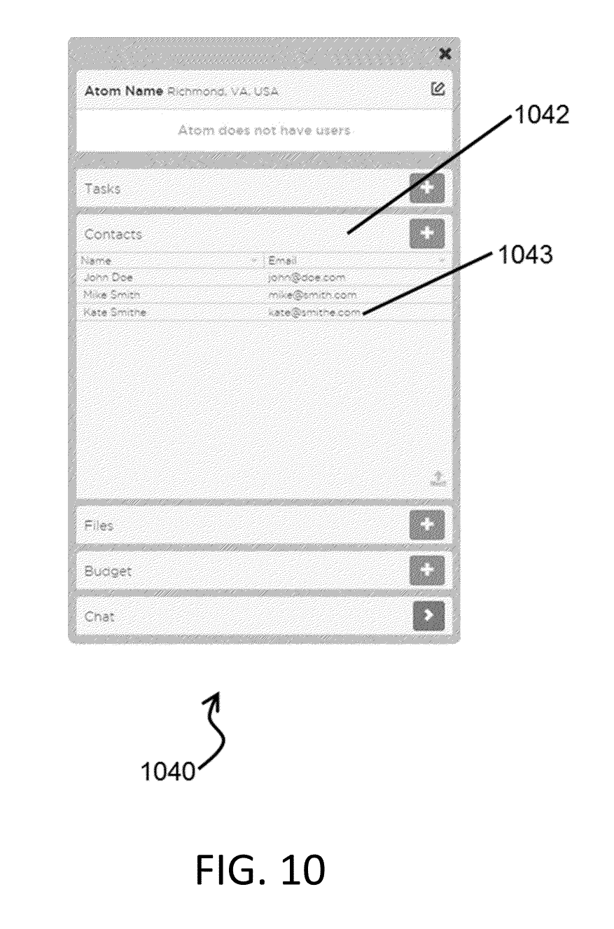

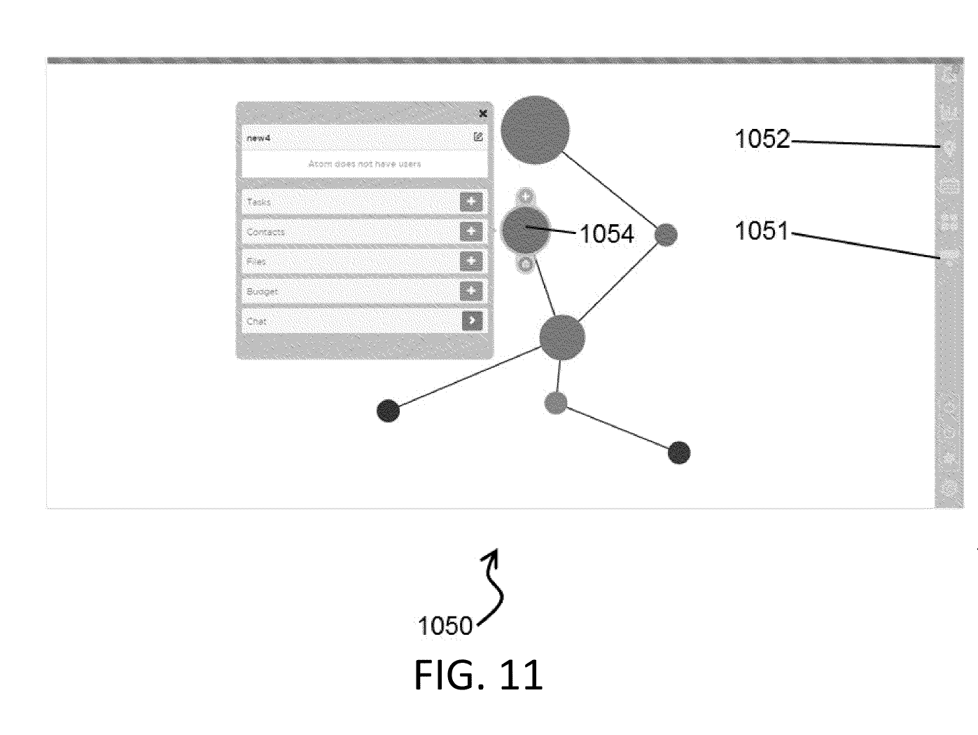

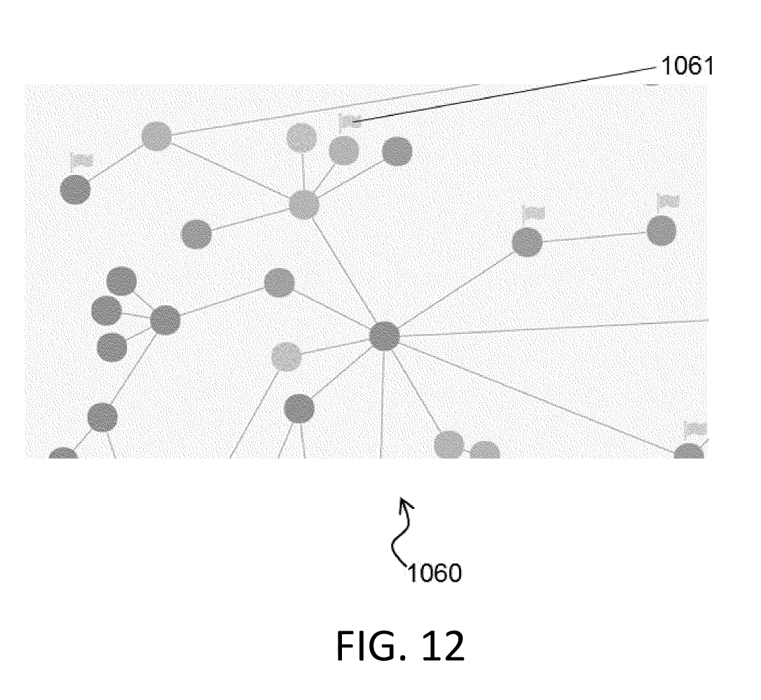

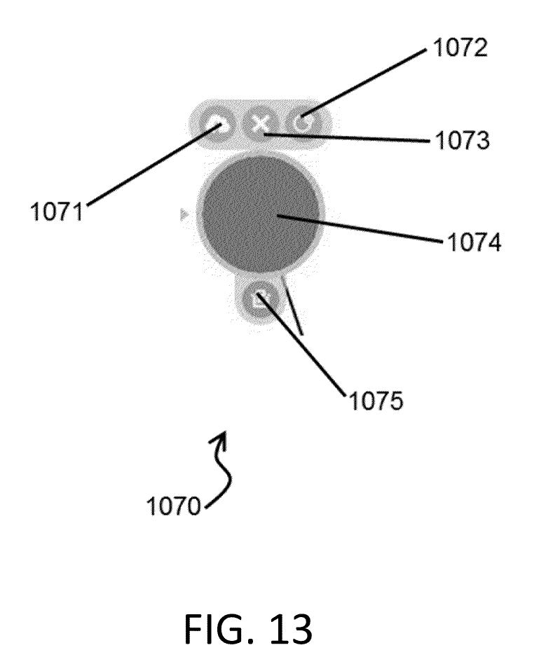

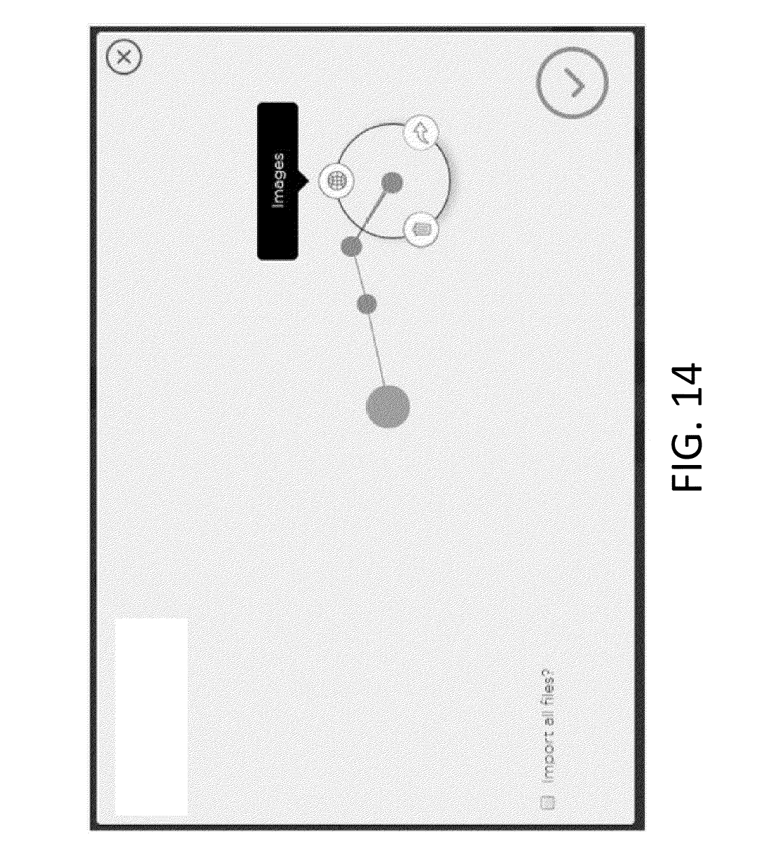

Additional examples of representative GUIs and features of GUIs are shown in FIGS. 8-14. FIG. 8 shows a Toolbar 1020 with Files 1024 and Tasks 1026. The Toolbar 1020 displays Atom name, location, and color 1021. It also shows Users 1022 shared on the Atom, Files 1024 stored in the Atom, and Tasks 1026 created in the Atom. FIG. 9 shows a Toolbar 1030 with an Edit function; Edit Bar 1032 appears when “Edit” is selected. FIG. 10 shows a Toolbar 1040 with Contacts 1042; Toolbar 1040 shows Contacts 1042 stored to the Atom and allows user to select an individual Contact 1043 to view expanded information or edit the Contact 1043. FIG. 11 shows a General Network screen 1050, which includes a Toggle 1051 to show titles, Toggle 1052 to show map, and Atom 1054, which can be clicked to show Atom Creation Context Menu. FIG. 12 shows a General Network with Search Results 1060 displayed; clicking Flags 1061 allows users to view results of a search. FIG. 13 shows a Context Menu 1070. Clicking Icon 1071 allows a user to import Atoms using the Application Programming Interface (API). Clicking Icon 1072 allows a user to add a single new Atom, while clicking Icon 1073 allows a user to open and close “Add new Atom” submenu. Context Menu 1070 appears when Atom 1074 is selected. The black line extending from Atom 1074 represents the link (parent-child relationship) between Atom 1074 and other atom(s) (not shown). Clicking Trash Icon 1075 allows a user to delete the Atom 1074. Finally, FIG. 14 shows an API import screen.

The GUI may allow a user to perform these tasks through the use of toggle switches, check boxes, pull-downs, command buttons, and the like. Further, the GUI may show features of this disclosure such as mapping of hierarchical data into individual nodes. A skilled artisan will appreciate how such graphical features may be implemented for performing the tasks of this disclosure. In one embodiment, remote computers may access the GUI through a cloud computing server. Such graphical controls and components are reusable class files that are delivered with a programming language. For example, pull-down menus may be implemented in an object-oriented programming language wherein the menu and its options can be defined with program code. Further, some programming languages integrated development environments (IDEs) provide for a menu designer, a graphical tool that allows programmers to develop their own menus and menu options. The menu designers provide a series of statements behind the scenes that a programmer could have created on their own. The menu options may then be associated with an event handler code that ties the option to specific functions. Toggle switches, check boxes, and command buttons may be implemented similarly through the use of code or graphical tools.

The present embodiment of this disclosure can be used as described above. However, other embodiments can be used in many ways including (but not limited to): the mapping of systems, monitoring of systems, mapping of networks, monitoring of networks, creating workflows, managing workflows, social network analysis (SNA), and as a social media tool.

### Systems Mapping/Monitoring

Embodiments can be used for the mapping and/or monitoring of systems and/or networks. This could be advantageous in many fields including (but not limited to) construction, medicine, flow monitoring, and sensor mapping.

For example, in construction, embodiments can be used for site management and to monitor the workforce as they enter and exit various construction sites. In addition, contractor workflow and requests for proposals can be mapped in real time, giving construction project managers a much clearer picture of how their resources and manpower are being utilized. In embodiments, mapping of the workflow would take all of the different parties on a given project and display their relationships with one another, as well as with various variables such as common contacts, files, tasks, and so on.

In the medical world, embodiments can be tied in with existing remote patient monitoring systems and used to passively monitor patients and their statuses. By presenting this information in a dashboard that can quickly alert nurses and/or staff, the method of this disclosure gives hospitals a clear advantage in response time. Such a dashboard could display such data as the heart-rates, equipment statuses, and blood pressures for a user-defined group of patients.

Any form of flow between at least two points can be mapped and monitored. Examples of such flows include motor-vehicle traffic, pipes and other liquid delivery systems, railways, air-traffic, inventory management within a store, foot-traffic within a store, and data transfer between computers on a network.

The ability to map the relationships between multiple sensors and devices will allow embodiments to be used as a way in which to monitor what is colloquially referred to as “the internet of things”. This concept, at its core, would see embodiments at hand as an interface to monitor and manage a network consisting of several hardware devices which are interacting with one another on multiple levels.

### Workflow Management

In project management, the creation and/or mapping of complex workflows can be a challenge. For example, visualizing and interacting with complex workflows gets very complicated given how many moving parts most project managers have to deal with, and how many different tools (many of which are doing the same thing) that the project manager has to use to interact with each group. Embodiments can be extended to give project managers the ability to create such workflows between teams and/or individuals, as well as track information relevant to time, resources, and scope of a project they are managing. Users can also use the method and platform of this disclosure to schedule tasks, events, and appointments with other users/teams on a given network.

As with applications to construction, embodiments of this disclosure can be used in any setting where time tracking comes into play. Users can create nodes corresponding to teams and/or individuals, and then define information flows between these nodes. Either through direct input or passive tracking, embodiments can monitor time spent on tasks and figure out the completion status of a given project and/or sub-task within a larger project.

Similarly, embodiments can be used in version tracking for documents and/or files as they are uploaded, or to show the flow of edits from one user/team to another user/team, thereby serving as a simple visual graph and/or graphic of a document's history.

For financial resources, embodiments can be used to quickly see where and how money is flowing within a network. This can also be extended to budget tracking and reporting, as well as budget and resource allocation.

Project managers need the ability to quickly set up a process flow on a given task. This flow can be modeled, monitored, and executed within embodiments of this disclosure. Project managers would set up their resources as nodes and then put conditional flow requirements between nodes. Therefore, when one node meets a set of conditions, a handoff of information and data is made to the next node in the flow. Using algorithms and user inputs, some of these tasks and handoffs can be automated, allowing for even more ease of management. Such algorithms could look at both the user's past workflows as well as anonymized user trends from the site at large to propose a specific workflow or to propose changes to a designed workflow to increase efficiency.

One of the main parties in a project flow is the client. Embodiments of this disclosure can be used to keep a client up to date by providing them with a “token” (e.g., an Atom with passive monitoring and feedback capabilities) that displays relevant statistics and status updates regarding a given project and/or node. These tokens can be embedded on client sites, used by a client in crowdfunding campaigns, and shown to any parties the client grants access to.

### Social Media/Other

Other extensions can give users the ability to export entire workflows, collaborate on the creation of workflows using open canvasses, and simplify crowdfunding by breaking up an idea into a series of nodes and requesting funds for each node.

Embodiments of this disclosure also have relevance to social network analysis and social networking in general. Users can map their social networks and quickly see how various individuals and/or groups interact. Users can also view updates from various social media platforms with ease.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A method of presenting data on a virtual canvas, the method comprising:
importing and consolidating hierarchical data from multiple data storage and/or project management platforms;
sorting and mapping the hierarchical data into a collection of a series of data points with parent-child relationships;
assigning a node to each data point, populating each node with meta-data associated with the data point the node represents, and displaying the nodes and their parent-child relationships on a virtual canvas;
creating a collaborative environment on the virtual canvas by converting each data point into a collaborative node that allows for sharing of and collaboration at the nodes between users by way of a chat interface, file sharing platform, and/or content management system; and
re-configuring the relationships between collaborative nodes using a computer processor to relate and sort data according to user-defined criteria, moving one or more of the data points to a different position on the virtual canvas, and displaying the nodes and their re-configured parent-child relationships on the virtual canvas.

2. The method of claim 1, further comprising presenting the hierarchical data as a graph or graphic on the virtual canvas.

3. The method of claim 1, further comprising performing the mapping of the hierarchical data according to user-defined criteria.

4. The method of claim 1, further comprising analyzing hierarchical structure, metadata, and associated data for the hierarchical data during the reconfiguring.

5. The method of claim 1, further comprising presenting the parent-child relationships as one or more branches between nodes and providing an ability to edit the one or more branches by removing and rearranging the nodes and branches or by importing metadata, associated data, and/or links to metadata and/or associated data.

6. The method of claim 1, wherein the collaboration at the nodes involves one or more of task or project management, task or project tracking, task or project scheduling, file storage, and/or file management.

7. The method of claim 1, further comprising:
assigning nodes to collections of data, wherein the nodes are capable of:
providing for the import and creation of files;
providing for the sharing of files;
providing an ability to assign and/or monitor tasks, schedules, and/or contacts relevant to each node.

8. The method of claim 1, wherein the node(s) is a digital virtual container capable of collecting, storing, and presenting any data and/or metadata requested by an algorithm and/or user input.

9. The method of claim 1, wherein the node(s) is capable of providing users with a user interface for displaying relationships between data.

10. The method of claim 1, wherein the node(s) is capable of providing users with a user interface through which users can collaborate and communicate.

11. A non-transitory computer-readable storage medium storing one or more programs, the one or more programs comprising instructions, which when executed by a computing device are capable of causing the device to:
import and consolidate hierarchical data from multiple data storage and/or project management platforms;
sort and map the hierarchical data into a collection of a series of data points with parent-child relationships;
assign a node to each data point, populate each node with meta-data associated with the data point the node represents, and display the nodes and their parent-child relationships on a virtual canvas;
create a collaborative environment on the virtual canvas by converting each data point into a collaborative node that allows for sharing of and collaboration at the nodes between users by way of a chat interface, file sharing platform, and/or content management system; and
re-configure the relationships between collaborative nodes using a computer processor to relate and sort data according to user-defined criteria, move one or more of the data points to a different position on the virtual canvas, and display the nodes and their re-configured parent-child relationships on the virtual canvas.

12. The computer-readable storage medium of claim 11, wherein the instructions, which when executed by a computing device, are capable of causing the device to present the hierarchical data as a graph or graphic on the virtual canvas.

13. The computer-readable storage medium of claim 11, wherein the instructions, which when executed by a computing device, are capable of causing the device to perform the mapping of the hierarchical data according to user-defined criteria.

14. A graphical user interface on a computer comprising a dashboard configured for:
a) displaying a visual representation of hierarchical data;
b) displaying the hierarchical data as a plurality of collaborative nodes:
wherein one or more of the plurality of nodes are configured for enabling collaboration and communication by way of the nodes; and
wherein one or more of the plurality of nodes is a digital container capable of collecting, transferring, storing, linking, and/or displaying data and/or metadata requested by an algorithm and/or user input;
c) displaying relationships between data provided by the nodes; and
d) reconfiguring a structure of stored and/or linked data.

15. The graphical user interface of claim 14, wherein the graphical user interface is configured for displaying the visual representation of the hierarchical data as a graph and/or graphic.

16. The method of claim 1, wherein the algorithm smartly predicts what collaborative features to include on a node based on the data point the node is created from.

17. The method of claim 1, wherein the importing is performed using one or more application programming interfaces (APIs) and/or one or more direct interfaces with one or more computing devices.

18. The method of claim 1, wherein the converting comprises assigning nodes to each datapoint and populating the nodes with meta-data associated with the data point the node represents.

19. The method of claim 18, wherein the meta-data is selected from Geodata, Dates, Times, Keywords, Contacts, Metadata, Hit Counts, Number of Files, and/or Number of Folders.
